(19) United States
(12) Patent Application Publication
(10) Pub. No.: US 2020/0104259 A1
(43) Pub. Date: Apr. 2, 2020

(54) SYSTEM, METHOD, AND APPARATUS FOR SNAPSHOT PREFETCHING TO IMPROVE PERFORMANCE OF SNAPSHOT OPERATIONS

(71) Applicant: Intel Corporation, Santa Clara, CA (US)

(72) Inventors: Ren Wang, Portland, OR (US); Lawrence C. Stewart, Wayland, MA (US); Binh Pham, Hillsboro, OR (US); Andrew Herdrich, Hillsboro, OR (US); Venkata Krishnan, Ashland, MA (US); Anil Vasudevan, Portland, OR (US); Joseph Nuzman, Haifa (IL); Tsung-Yuan Tai, Portland, OR (US)

(21) Appl. No.: 16/147,346

(22) Filed: Sep. 28, 2018

(51) Int. Cl. G06F 12/0862; G06F 12/0817; G06F 12/0842

(52) U.S. Cl. CPC G06F 12/0862; G06F 12/0826; G06F 2212/621; G06F 2212/602; G06F 12/0842

(57) ABSTRACT

A snapshot prefetcher to perform snapshot prefetching to improve performance of snapshot read operations. An apparatus embodiment includes a snapshot read tracking circuitry to track snapshot read requests made by a first processor core to read a plurality of cache lines, and to detect a snapshot read access stream based on the tracked snapshot read requests. A snapshot prefetch issuing circuitry of the apparatus to issue, based on the detected snapshot read access stream, one or more snapshot prefetch requests, including a first snapshot prefetch request to prefetch data from a first cache line stored in, and owned exclusively by, a first storage location outside the first processor core. The snapshot prefetch issuing circuitry further to store the prefetched data in a second storage location within the first processor core, wherein after the prefetch, exclusive ownership of the first cache line is to remain with the first storage location.

### TECHNICAL FIELD

Embodiments of the invention described herein relate generally to the field of data prefetchers in a computer system. In particular, the disclosure relates to prefetching snapshots of data.

### BACKGROUND ART

Modern multi-core processors typically include multi-level cache hierarchies and coherence protocols that are intended to keep data closer to the core(s). The goal here is to reduce data access latencies by utilizing the temporal and/or spatial localities that are typically present in neighboring data accesses. By storing data in local caches, performance is improved when subsequent accesses reference the same data (temporal locality) or nearby data (spatial locality) as previous accesses. To avoid conflicts among different copies of data, elaborate coherence protocols are often used to keep data consistent between the cores. In some cases, however, coherence protocols may unintentionally cause ownership of data, which is shared by multiple cores (e.g., a producer core and a consumer core), to be transferred back-and-forth between them. While maintaining data coherence and consistency is important, in some cases, however, a data requestor is only interested in obtaining the data rather than its ownership. In such scenarios, unnecessary ownership changes not only cause performance degradations in subsequent accesses, but also incur costs in power consumption, connection bandwidth, and cache space.

### BRIEF DESCRIPTION OF THE DRAWINGS

The invention may best be understood by referring to the following description and accompanying drawings that are used to illustrate embodiments of the invention. In the drawings:

FIGS. 1A-1B illustrate the underlying interactions in a typical producer/consumer data exchange between two processors using a read/load operation;

FIGS. 2A-2B illustrate the underlying interactions in a producer/consumer data exchange between two processors when a snapshot read operation is used in accordance to an embodiment;

FIG. 3 is a block diagram illustrating an exemplary system on which embodiments of the present invention may be implemented;

FIG. 4 is a block diagram illustrating an embodiment of a snapshot prefetcher;

FIG. 5 is a block diagram illustrating an embodiment of a snapshot buffer for storing data prefetched by the snapshot prefetcher;

FIG. 6 is a flow diagram illustrating the operations and logic for performing snapshot prefetching according to an embodiment;

FIG. 7 is a flow diagram illustrating the operations and logic for processing a read request according to an embodiment;

FIG. 8A is a block diagram illustrating both an exemplary in-order pipeline and an exemplary register renaming, out-of-order issue/execution pipeline according to embodiments of the invention;

FIG. 8B is a block diagram illustrating both an exemplary embodiment of an in-order architecture core and an exemplary register renaming, out-of-order issue/execution architecture core to be included in a processor according to embodiments of the invention;

FIG. 9 is a block diagram of a single core processor and a multicore processor with integrated memory controller and graphics according to embodiments of the invention;

FIG. 10 illustrates a block diagram of a system in accordance with one embodiment of the present invention;

FIG. 11 illustrates a block diagram of a second system in accordance with an embodiment of the present invention;

FIG. 12 illustrates a block diagram of a third system in accordance with an embodiment of the present invention;

FIG. 13 illustrates a block diagram of a system on a chip (SoC) in accordance with an embodiment of the present invention; and

FIG. 14 illustrates a block diagram contrasting the use of a software instruction converter to convert binary instructions in a source instruction set to binary instructions in a target instruction set according to embodiments of the invention.

### DETAILED DESCRIPTION

Embodiments of system, method, and processor for utilizing snapshot operation to prefetch data for subsequent reads are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the Figures herein may be referred to by their labels in the Figures, rather than by a particular reference number.

Data movement services between cores of a multi-core processor (e.g., between producer cores and a consumer cores) move copies of data between them through read and write operations. For optimal performance, both producer and consumer cores save copies of data in their local caches based on locality considerations. However, as the cores seek and update data, these locality considerations are altered. For example, in some coherent memory architectures, the act of reading or updating data changes the data's coherency state and position in a cache hierarchy. In other situations, the messaging system running on a single cache-coherent domain (e.g., a processor) may unintentionally cause transfer of data ownership from one core to another, when in fact, it is only the data that needs to be transferred. These changes in locality consideration not only degrade performance, but also consume power, coherency bandwidth, and cache space.

To address this issue, a snapshot read operation (snapshot read) was realized. The snapshot read is a specialized data movement operation that moves a copy of the requested data from the source to the destination without altering the coherence and/or directory state of the requested data anywhere within the cache-coherent domain. The data being returned by the snapshot read is a snapshot of the content at the target memory address at the time when the read is performed. The snapshot read may be triggered by executing a snapshot instruction. According to an embodiment, the snapshot instruction specifies or identifies the target memory address from which a snapshot of the data is to be taken. When the snapshot instruction is decoded by a decoder and executed by an execution unit, the triggered snapshot read operation allows data to be read or sourced in situ with respect to the cache hierarchy and coherency. For example, a consumer, by executing a snapshot instruction, can read data from a producer without changing the coherence state and/or the location of the original data. There are numerous performance benefits of the snapshot read operation. In one aspect, since data accessed by the snapshot read operation is not stored into the consumer's cache, there is no risk of the snapshot read data displacing any of the currently cached data, where the absence of some may negatively impact performance (i.e. reduce capacity misses). Moreover, since the snapshot read does not change the coherence state of the original data, a core that currently has write access to the original data will not lose that access and thus avoids the cost of reacquiring that access during subsequent writes (i.e. read-for-ownership cost).

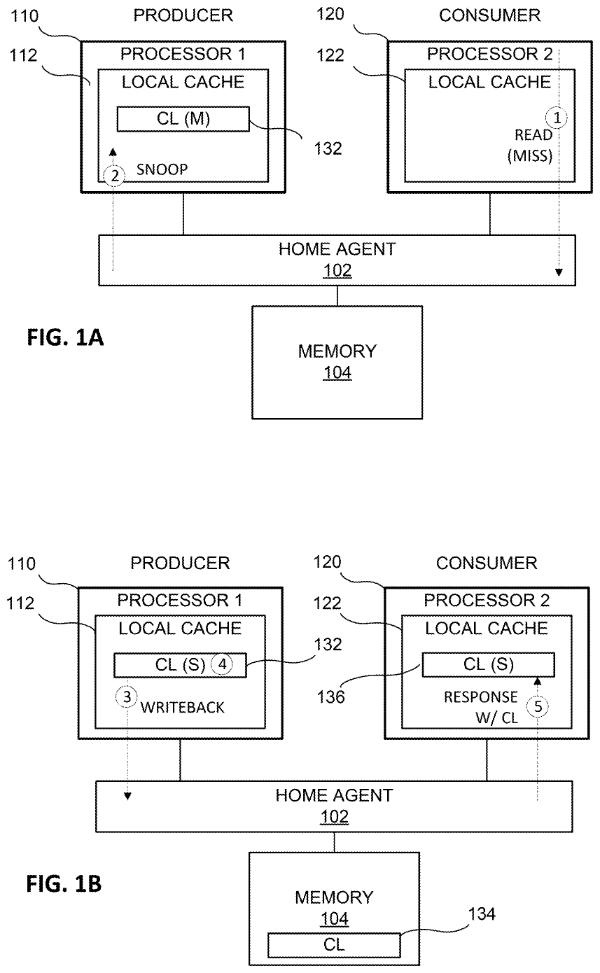

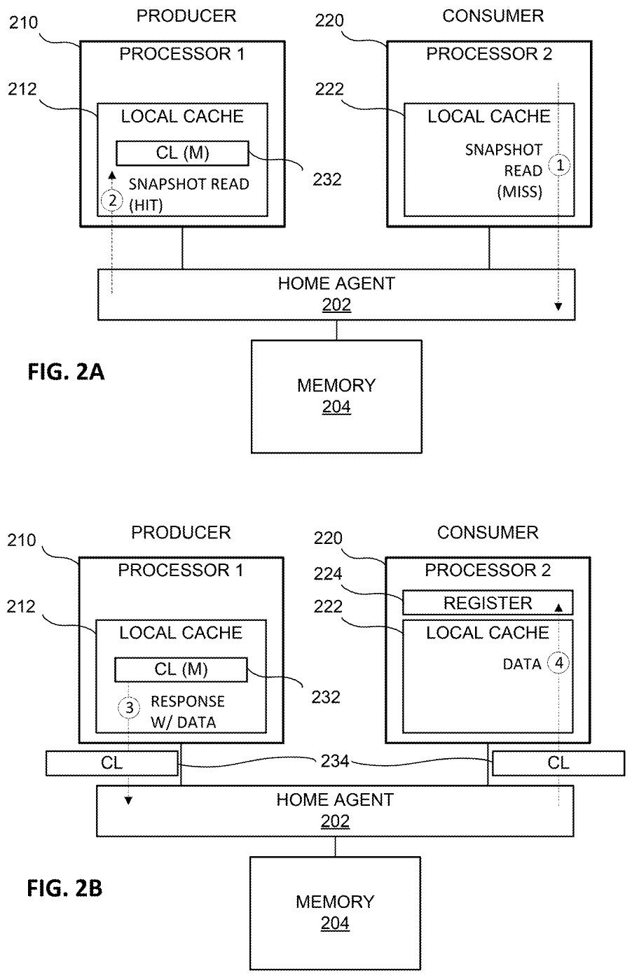

Illustrated in FIG. 1A-1B is an embodiment of a producer/consumer data exchange using conventional read/load operations. Another embodiment of the producer/consumer data exchange performed using snapshot read operation is shown in FIGS. 2A-2B. The unit of data to be transferred is referred to herein as a cache line or cache block, each cache line may contain 8 KB, 16 KB, 32 KB, etc. of data depending on the implementation. The producer and consumer shown in FIGS. 1 and 2 may be logical/physical processors, threads, or cores. Moreover, for simplicity, a single local cache is illustrated for each producer and consumer. It is understood, however, that any number of additional levels of cache may be implemented. Some of the caches may be shared between the producer and the consumer.

In FIG. 1A, at initial state, a cache line (CL) 132 is stored in the local cache 112 of processor 1 110 (producer). The cache line 132 is associated with a cache coherence state, or coherence state for short, of modified (M) or exclusive (E), indicating that processor 1's local cache 112 has sole ownership of the only valid instance of cache line 132. Thereafter, processor 2 120 (consumer) seeks to read the data in cache line 132 by issuing and/or triggering a read/load operation. However, since the only valid instance of cache line 132 resides in the local cache 112 of processor 1 110, the read by processor 2 120 misses its local cache 122. This is illustrated by operation 1 (i.e., 1 enclosed by circle). In response to the miss, the home agent 102 issues a snoop request for cache line 132 to processor 1 110, as illustrated by operation 2. The home agent 102 may include or have access to a directory that tracks ownership and/or status of each cache line cached by processors 1 and 2. Next, as illustrated by FIG. 1B, if cache line 132 in the local cache 112 of processor 1 110 is in modified (M) state and thus “dirty,” cache line 132 is written back to memory 104 as cache line 134 via a writeback (i.e., operation 3). Additionally, the coherency state of cache line 132 in local cache 112 of processor 1 110 is changed from modified (M) to shared (S), as illustrated by operation 4. On the other hand, if the state of the requested cache line 132 was exclusive (E) instead of modified (M), no writeback required. Instead, the coherency state of the requested cache line 132 is simply changed from exclusive (E) to shared (S).

Next, a copy of cache line 132 is provided to processor 2 120 in a response to processor 2's read miss (operation 5). This copy of cache line 132 is saved into the local cache 122 as cache line copy 136 and marked as (S)hared. To summarize, as a result of the read issued by processor 2 120, the cache coherence state of cache line 132 in producer's local cache 112 is changed (e.g., M→S or E→S), and a copy of the cache line 136 is cached into the consumer's local cache 122.

In contrast, FIGS. 2A and 2B illustrate the underlying interactions when a snapshot instruction is used instead of a read/load instruction. At initial state, similar to that of FIG. 1A, a cache line (CL) 232 is stored in the local cache 212 of processor 1 210 (producer). The cache line 232 is associated with a cache coherence state of modified (M) or exclusive (E), indicating that processor 1's local cache 212 has sole ownership of the only valid instance of cache line 232. Thereafter, processor 2 220 (consumer) seeks to read the data contained in cache line 232. Instead of conventional read/load operations, processor 2 220 executes a snapshot instruction which specifies the memory address of cache line 232 from which data is to be read. In some embodiments, the snapshot instruction may additionally specify a destination memory address and/or the location to which a response is to be stored. The execution of the snapshot instruction may trigger one or more snapshot operations or requests.

Initially, since the only valid instance of cache line 232 resides in the local cache 212 of processor 1 210, the snapshot request issued by processor 2 220 misses its local cache 222. This is illustrated by operation 1. Subsequent to the miss, home agent 202 may forward the snapshot request and/or issues a snoop to processor 1 210. In some embodiments, the request or snoop to processor 1 210 includes a hint indicating that only the data from the cache line is requested. Next, as shown in FIG. 2B, responsive to the request, processor 1 210 sends a cache line copy 234 to the home agent 202 in operation 3. The home agent 202, in turn, sends the cache line copy 234 to processor 2 220 in operation 4. Alternatively, the cache line copy (i.e., data) may be sent directly from processor 1 210 to processor 2 220 without going through home agent 202. The cache line copy 234 is then stored directly into a local storage of processor 2, such as a register or a local buffer, to be consumed. No change is made to the cache coherence state or location of the original cache line 232. In other words, original cache line 232 still resides in the local cache 212 of processor 1 210 and maintains its cache coherence state (e.g., modified (M) or exclusive (E)), after execution of the snapshot instruction by processor 2 220.

By not disturbing the coherence state and the locality of the cache line that was accessed, the snapshot instruction significantly reduces the performance penalties associated with unnecessary cache line bouncing between the producer and the consumer. However, to preserve the benefits of the snapshot instruction, certain features within the processor, such as prefetchers, are disabled with respect to snapshot operations in order to avoid causing unnecessary movement of cache lines.

Normal load/store operations trigger prefetchers to prefetch extra cache lines in anticipation of future demands. This is crucial in hiding memory access latency and improving performance as cache lines are preemptively fetched and made available locally to the consuming core before they are actually needed. Prefetching data is especially important when the target cache lines are located far away from the consumer, such as in the system memory or in a remote core/socket. With snapshot read, due to its non-cache-coherent characteristic, conventional prefetchers cannot be triggered as they are today because doing so would cause unintentional and undesirable changes in the coherence state and/or location of the prefetched cache lines. For instance, when an application uses snapshot instructions to read data in a block of cache lines (snapshot read), cache lines located in nearby regions run the risk of becoming prefetch candidates if snapshot reads are taken into account by the prefetchers. When these neighboring cache lines are fetched by the prefetcher and stored into a local cache of the consumer, their coherence state and locality are necessarily altered. This directly contradicts one of the main benefits for using snapshot reads in the first place, which is to avoid unnecessary and unintended cache line movements within the cache hierarchy. As such, in order to preserve the benefits of snapshot read, conventional prefetchers should not be triggered when data are accessed via snapshot read.

Disabling prefetchers with respect to snapshot reads, however, is not without penalties. With prefetchers disabled, the use of snapshot reads suffers performance degradations in situations where a large contiguous patch of data is moved across producer and consumer cores. Understandably, this is because the usual benefits associated with prefetchers are no longer present. When the data is moved across different cores, due to long core-to-core latency (e.g., ˜120 cycles) and limited fill buffer (FB) capacity, there are usually not enough in-flight snapshot requests to hide the long latency and to maintain a desired throughput. This performance drop may even nullify the benefits of snapshot reads, if the total bandwidth to access a block of data via snapshot reads becomes less than the total bandwidth to access the same block of data with conventional reads/loads. It is, therefore, desirable that some form of data prefetching is maintained for snapshot reads, as prefetching introduces more in-flight operations than what is otherwise available to the core itself, thereby improves core-to-core bandwidth.

Aspects of the “snapshot prefetcher” described herein introduce a new form of data prefetching that takes into account snapshot reads. According to an embodiment, the snapshot prefetcher behaves differently than conventional prefetchers in that it complements the snapshot instruction by prefetching data using snapshot reads and thereby avoiding making unintentional changes to the coherence state and/or the locality of the original cache line. In other words, the snapshot prefetcher provides the same performance benefits as regular, conventional prefetchers while preserving the desired behavior of the snapshot instruction.

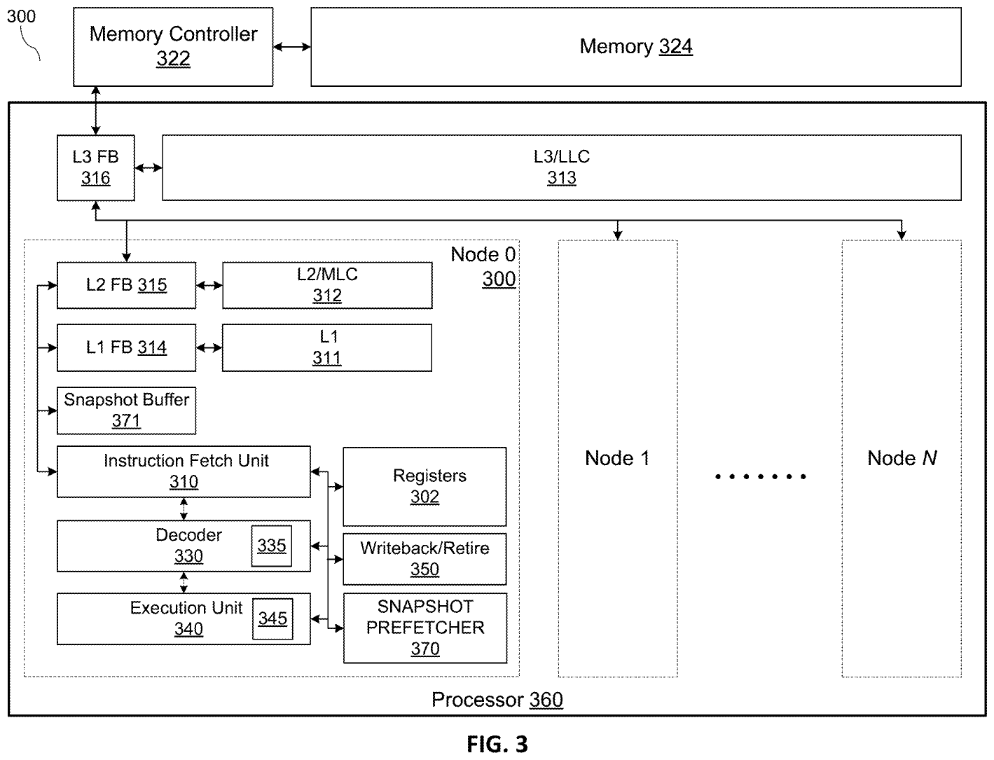

FIG. 3 illustrates an exemplary system on which embodiments may be implemented. System 300 includes processor 360 that is communicatively coupled to memory 324. Processor 360 may be a chip multi-processor (CMP) that includes one or more nodes. Each of the nodes may constitute or include: a processor core (core), a logical processor, or a hardware thread. The details of a single node (i.e., node 0) are illustrated in FIGS. 3 for simplicity. It will be understood, however, that each of the other nodes may have the same set of logic, components, circuitry, and/or configuration as node 0. For example, each node may include a set of registers 302, a level 1 cache (L1) 311, and a L2 (L2) or mid-level cache (MLC) 312. In some embodiments, processor 360 may further includes a level 3 (L3) cache or LLC 313 that is communicatively coupled to, and shared by, all the nodes. In other embodiments (not shown), the L3/LLC 313 is physically distributed and logically shared among the nodes. Each of L1, L2/MLC, and L3/LLC caches, according to an embodiment, is managed by a respective cache agent or controller (not shown) and usable for caching instructions and data according to a specified cache management policy. One or more cache agents or controllers may be used to perform the functions of a home agent, which may utilize directories to ensure and enforce cache coherence. In at least some embodiments, the cache management policy further includes a cache eviction/replacement policy. Each level of the caches may also have associated with it one or more buffers (314, 315, 316) that are used for temporarily storing data returned from access requests. The buffers may include snapshot buffers that are used exclusively for storing data return from snapshot read requests, regular buffers that are used for storing data returned from regular load/read requests, or hybrid buffers that store data returned from both snapshot read requests and regular load/read requests. Each entry of the hybrid buffer may include an indicator for distinguishing the type of data (e.g., data from snapshot read versus data from regular load/read) stored within each entry. In addition, each buffer may be associated with a respective eviction/replacement policy.

The instructions and data stored within the various processor caches and buffers are managed at the granularity of cache lines which may be a fixed size (e.g., 64, 128, or 512 bytes in length). Each node of the exemplary embodiments further includes an instruction fetch unit 310 for fetching instructions from main memory 324 via memory controller 3 22 and/or from the shared LLC 313 via L3/LLC agent 316; a decoder 330 for decoding the instructions (e.g., decoding program instructions into micro-operations or “uops”); an execution unit 340 for executing the decoded instructions; and a writeback unit 350 for retiring the instructions and writing back the results (e.g., to main memory 324). Furthermore, decoder 330 may include specific logic or circuitry 335 for decoding snapshot instructions into micro-operations such as snapshot operations. Similarly, the execution unit may also include specific logic or circuitry 345 for executing the decoded snapshot instructions by performing one or more snapshot operations, such as initiating a snapshot read to read data. The snapshot instruction may include one or more operand. At least one of the operands may specify the memory address of a cache line from which data is to be read.

According to some embodiments, each node of processor 360 also includes one or more snapshot prefetchers 370. The snapshot prefetcher may be implemented as software program, hardware circuits or circuitry, or a combination of both. The snapshot prefetcher and/or its functions may be implemented as a standalone prefetcher or included as part of existing prefetchers. In some embodiments the snapshot prefetcher monitors and tracks the data access patterns within the node by monitoring the execution of snapshot instructions, including the associated operations, by the node. When a snapshot read access stream is detected, the snapshot prefetcher issues snapshot prefetch requests based on the detected access stream to bring data into storage location(s) local to the node. The local storage locations may include dedicated buffers such as snapshot buffer 371, existing buffers such as fill buffers 314-316, and/or local caches such as L1/L2/L3 cache 311-313. It is important to note that if existing buffers or local caches are used to store the data prefetched by snapshot read, additional mechanisms, as will be detailed below, are utilized to ensure that these data are not treated like normal prefetched data.

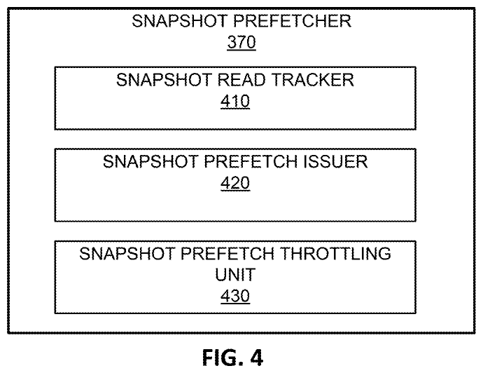

FIG. 4 illustrates embodiments of a snapshot prefetcher. The snapshot prefetcher 370, including its components and functionalities, may be implemented by hardware logic/circuitry, state machine, or any other suitable structure. The snapshot prefetcher 370 may include a snapshot tracker 410, a snapshot prefetch issuer 420, and a snapshot prefetch throttling unit 430.

The snapshot tracker 410 monitors snapshot reads to detect snapshot read access streams. This may include monitoring the instructions executed by the execution unit or monitoring the bus for snapshot read requests. Once a snapshot read access stream has been detected by the snapshot tracker 410, the snapshot prefetch issuer 420 issues snapshot prefetch requests to prefetch data in accordance to the detected access stream. For instance, the snapshot prefetch issuer 420 may issue a snapshot read request to fetch the next cache line to be accessed in the detected access stream. The fetched cache line is stored in a snapshot buffer.

The snapshot prefetch throttling unit 430 monitors the effectiveness and/or the resource usage by the snapshot prefetcher and modifies the behavior of the snapshot prefetcher accordingly. In one embodiment, the snapshot prefetch throttling unit 430 includes one or more counters to track the number of cache lines prefetched by the snapshot prefetcher and the number of prefetched cache lines that are actually being used to fill snapshot read requests. If a large portion of the prefetched cache lines are being timed-out or evicted before they are accessed, the snapshot prefetch throttling unit 430 may adjust the prefetching parameters, such as the training-to-prefetch threshold, to make the prefetcher operate less aggressively. On the other hand, if a high percentage of the prefetched cache lines are being accessed by snapshot read requests, the snapshot prefetchers may increase the prefetching activities.

According to an embodiment, the snapshot prefetcher monitors and tracks only the cache line accesses that are triggered by snapshot instructions (e.g., snapshot reads). When the snapshot prefetcher detects a snapshot read access stream, it issues snapshot read requests based on the detected stream to speculatively fetch data from cache lines or memory locations that are likely to be accessed in the future. The snapshot prefetcher may be implemented as a new prefetcher that is separate from existing prefetchers.

In some embodiments, existing prefetchers (e.g., data prefetchers for level 1 and/or level 2 cache) are modified to include the functionality of a snapshot prefetcher, by taking into account snapshot reads when making prefetch decisions. For instance, existing prefetchers may monitor both normal access requests and snapshot read requests but keeps track of them separately. When an access stream based only on normal access requests is detected, the prefetcher issues regular prefetch requests to retrieve the target cache lines and store them in the local cache as normal. On the other hand, when the detected access stream is based solely on snapshot read requests, instead of issuing regular load/read request, a snapshot read request is used to prefetch data from the target cache line into a local storage location (snapshot buffer) in the requesting core. The target cache line may be fetched form one of the cores or the system memory. No change is made to the cache coherence state and the locality of the target cache line. It is important to note that the data prefetched via the snapshot read request do not participate in the cache coherence protocol. The data fetched via the snapshot read is stored in the snapshot buffer and is only available to serve subsequent snapshot reads. According to an embodiment, the prefetched data remains in the snapshot buffer until it is displaced or evicted by other prefetched data or has timed-out. In some embodiments, the stored data may also be removed from the prefetch buffer once they are read by subsequent snapshot reads.

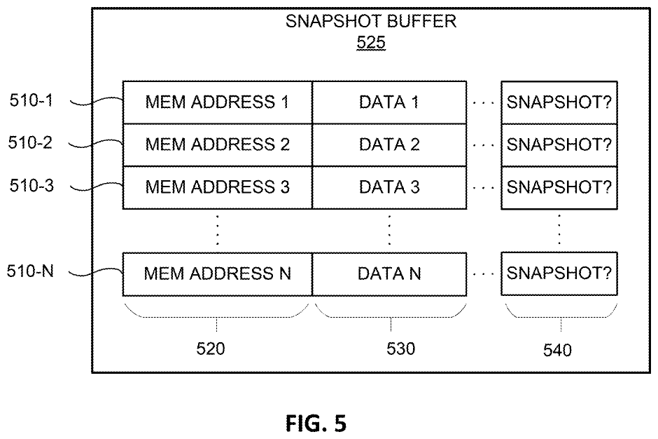

FIG. 5 illustrates an embodiment of a snapshot buffer for storing the data prefetched by the snapshot prefetcher. Additionally, the snapshot buffer 525 may also store data that are requested by the cores via snapshot instructions. The snapshot buffer 525 may be a dedicated storage location (e.g., 371), part of an existing storage location (e.g., fill buffers 314-16), or one of the caches 311-313. As noted above, data stored in the snapshot buffer may only be used to fill snapshot read requests. These data do not participate in memory cache coherence protocol. Each entry 510 of the snapshot buffer 525 may include a memory address field 520 and a data field 530. In embodiments where the snapshot buffer is part of existing storage location and thus includes other non-snapshot prefetched data, each entry may additionally include a snapshot field 540 to indicate whether or not the data in the corresponding entry is the result of a snapshot read request. In an embodiment, the snapshot field 540 is a single bit field. A set bit (i.e. 1) indicates that the entry contains data obtained via snapshot read request and thus may only be used to fill other snapshot read requests. A non-set bit (e.g., 0) indicates that the data in the entry may be used to fill any other types of data access request. The snapshot buffer 525 may additionally include other fields such as a valid field to indicate whether the corresponding entry is valid, a least recently used (LRU) field to indicate whether the corresponding entry is a candidate for eviction, and a timer field to indicate the age of the data stored in the corresponding entry.

In one embodiment, data fetched via the snapshot reads may be stored in a local cache, such as the L2 cache. Since caches are typically larger than buffers, this approach would enable large amount of data to be stored. According to the embodiment, an alias table is used to provide the address remapping for the data fetched via the snapshot reads, including those made by the snapshot prefetcher. Specifically, the alias table contains the dynamic mappings of target memory regions to private memory regions. Private memory regions are those that are part of the system memory address space but are specifically set aside and not typically accessed. One or more core-specific register (CSR) may be used to specify the portions of the system memory address space that are to be used as private memory regions. The use of the alias table allows the private memory regions to be dynamically recycled and remapped to different target memory ranges. In operation, data fetched via snapshot reads are stored directly to aliased memory addressees in the private memory region. When fulfilling a snapshot read request, the alias table is consulted and the target address in the snapshot read request is translated to the aliased memory address in the private memory region for retrieving data from the private memory region. The alias table need not be very big and may contain only enough entries (e.g., 1-8 entries) to accommodate active snapshot read requests.

Data stored in the snapshot buffers should be carefully managed because the snapshot buffer is likely to be small and, in the case of a shared buffer, will take resources away from other functions. Moreover, since data obtained via snapshot reads are not in the coherent domain and do not participate in the coherence protocol, any subsequent updates to the original data will not be reflected in the data in the snapshot buffer. As such, data in the snapshot buffer should be actively cleaned up to prevent very staled data being used to fill snapshot read requests. In the case where a shared buffer, such as the fill buffer, is used, snapshot prefetched lines should only occupy, at most, a limited portion of the shared buffer regardless of whether free entries are available. This constraint is to prevent potential live-lock situation where new snapshot read requests are waiting for fill buffer entries because they are all already occupied by snapshot read requests. The constraint is also intended to limit potential performance impact for other instructions as snapshot fetched lines are not allocated to cache like other lines and thus tend to spend more time in the shared buffer.

According to an embodiment, a cache line that is fetched via a snapshot read request may be deallocated from the snapshot buffer in the following scenarios:
1. When the cache line is accessed by a new snapshot read request. Upon such access, the cache line should be immediately marked as invalid to prevent subsequent snapshot read requests to the same address from getting a staled copy.
2. When a memory barrier or fence instruction is issued to enforce an ordering of memory operations. In such case, all snapshot-fetched lines should be invalidated.
3. When the cache line has timed out. Each cache line, when allocated into the snapshot buffer, is associated with a timer. When the timer expires, the associated cache line should be invalidated to purge stale data.
4. When the cache line is evicted according to the applicable eviction policy. As mentioned, the snapshot buffer for snapshot prefetched lines, whether dedicated and shared, is very limited in size. As such, a good eviction policy is needed to manage the space in the snapshot buffer. If a least recently used (LRU) policy is used, the oldest cache line in the snapshot buffer is first to be displaced to make room for other snapshot-read cache lines. The age of the cache line may be determined based on the associated time.

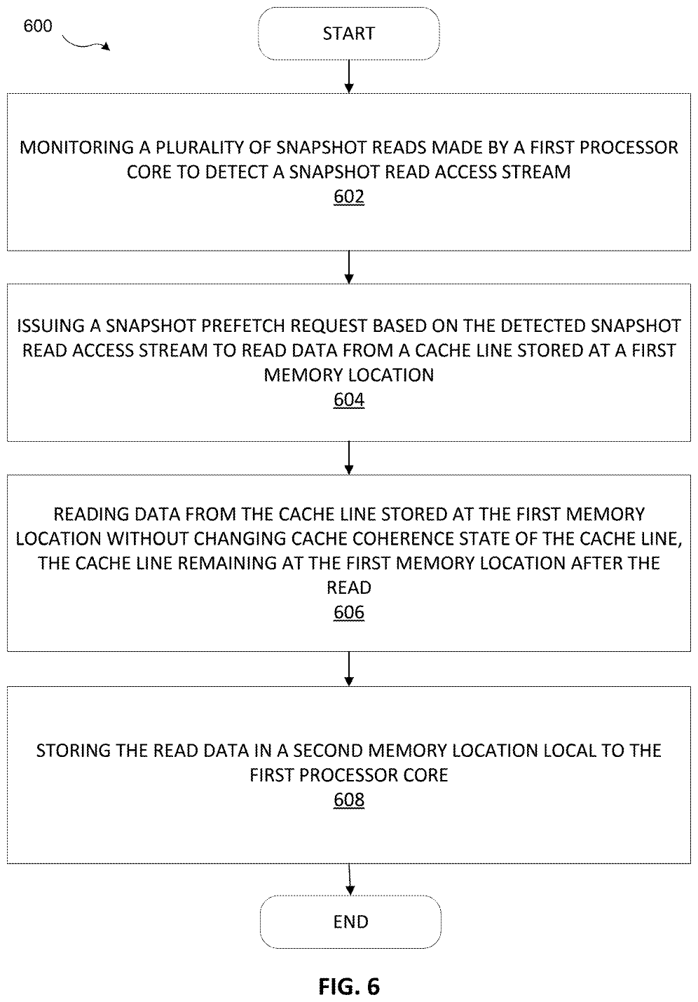

FIG. 6 illustrates embodiments of a method for snapshot prefetching. The method may be implemented in system 300 of FIG. 3. Specifically, according on an embodiment, the method 600 is performed by prefetcher 370. At block 620, the prefetcher 370, via snapshot access tracker 410, monitors a plurality of snapshot reads made by a processor core associated with the prefetcher to detect a snapshot read access stream. When a snapshot read access stream is detected, the prefetcher 370, via snapshot prefetch issuer 420, identifies cache lines that may potentially be accessed in the future by the processor core. At block 604, the snapshot prefetch issuer 420 issues a snapshot prefetch request (e.g., a snapshot read) based on the detected snapshot read access stream to read data from a cache line stored at a first memory location. The first memory location may be the cache of another processor core or node, or in the system memory. At block 606, the snapshot prefetch request causes data that is stored in the cache line at the first memory location to be read, but without changing the cache coherence state or ownership of the cache line. In addition, the cache line is to remain at the first memory location after the read with no change to its locality. At block 608, the data that is read from the cache line is stored at a second memory location local to the processor core that is associated with the prefetcher. The second memory location may be a dedicated buffer or an existing buffer of the processor core. The stored data does not participate in the cache coherence protocol and may only be used to serve subsequent snapshot read requests.

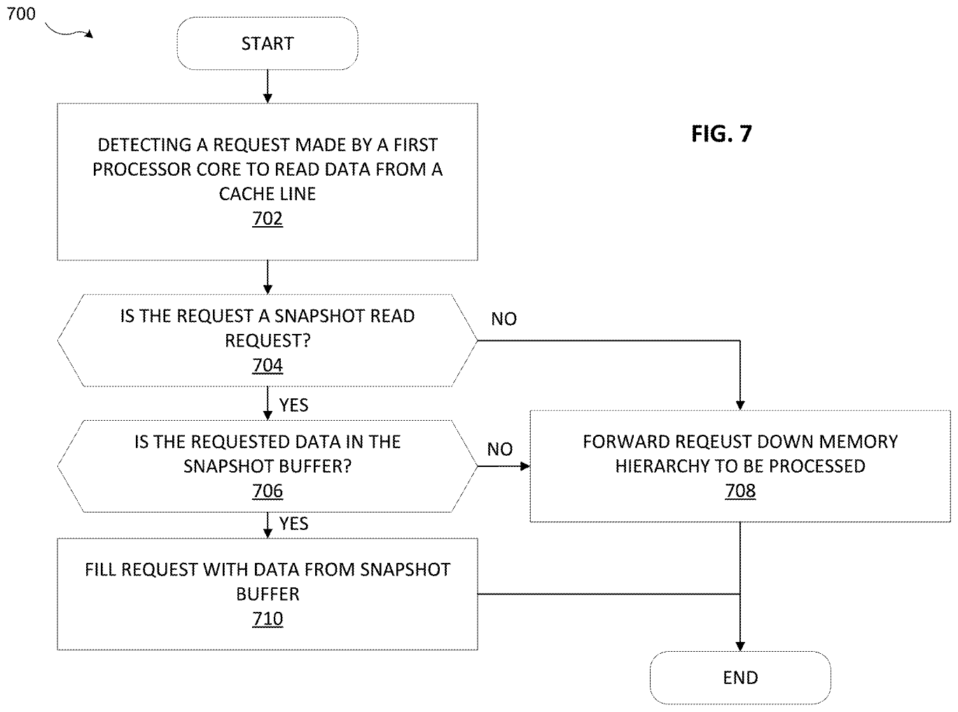

FIG. 7 illustrates embodiments of a method for processing read requests. Method 700 may be implemented in system 300 of FIG. 3. Specifically, according to an embodiment, method 700 is performed by the snapshot buffer or a controller of the buffer. At block 702, a request made by a first processor core to read data from a cache line is detected. A determination of whether the request is a snapshot read request is determined at block 704. A snapshot read request, according to an embodiment, is an access request that intends to take a snapshot of the data stored at the requested cache line, without altering the cache coherence state and the locality of the request cache line. In addition, the data read is via a snapshot read request is stored at a local buffer (snapshot buffer) of the first processor core and does not participate in the cache coherence protocol. If, at block 704, the request is not a snapshot read request, the request is processed as a normal read request at block 708. For example, the data in the requested cache line is read and any necessary changes to the cache coherence state (e.g., Exclusive→Shared or Modified→Shared) is made. The requested cache line is cached into the cache of the first processor core and participates in the cache coherence protocol. On the other hand, if, at block 704, the request is indeed a snapshot read request, a determination is made at block 706 on whether the data requested is already in the snapshot buffer of the first processor core. As discussed above, data in the snapshot buffer that were prefetched via snapshot prefetch requests may be associated with a field or attribute to indicate it as such. If the snapshot buffer does not contain the requested data, the snapshot read request is forwarded on to be processed at block 708. If the requested data is found in the snapshot buffer, then the data is used to fill or serve the snapshot access request at block 710.

An example of the present invention is an apparatus that includes a snapshot read tracking circuitry and a snapshot prefetch issuing circuitry. The snapshot read tracking circuitry tracks snapshot read requests made by a first processor core to read a plurality of cache lines. The snapshot read tracking circuitry may detect a snapshot read access stream based on the tracked snapshot read requests. Once a snapshot read access stream is detected, the snapshot prefetch issuing circuitry issues one or more snapshot prefetch requests based on the detected snapshot read access stream. The one or more snapshot prefetch requests includes at least a first snapshot prefetch request that is to prefetch data from a first cache line stored in, and owned exclusively by, a first storage location outside the first processor core. The prefetched data is to be stored in a second storage location within the first processor core. After the prefetch, exclusive ownership of the first cache line is to remain with the first storage location.

Each of the plurality of cache lines read by the first processor core via a snapshot read request may be associated with a respective cache coherence state. A snapshot read request is a request that, when executed, causes data stored in a target cache line to be read in a way such that after the data is read, the cache coherence state associated with the target cache line and the location in which the target cache line is stored are to remain the same. The first storage location that is outside the first processor core may be a cache of a second processor or may be the system memory that is shared by the first and second processor core. Each entry in the second storage location may include an indicator to indicate whether data stored in the entry is snapshot prefetched data. Snapshot prefetched data may only be used to fill snapshot read requests issued by the first processor core. Snapshot prefetched data may be removed from the second storage location if: 1) the snapshot prefetched data is accessed by a subsequent snapshot read request; 2) the snapshot prefetched data is evicted in accordance to an eviction policy associated with the second storage location; or 3) the snapshot prefetched data has timed out.

The apparatus may further include a snapshot prefetch throttling circuitry to track the ratio between the number of snapshot prefetched data in the second storage that have been accessed by subsequent snapshot read requests and the number of snapshot prefetched data that have been evicted from the second storage location or have timed out. Based on this ratio, the snapshot prefetch throttling circuitry may adjust the rate at which the snapshot prefetch circuitry issues snapshot prefetch requests.

Another example of the present invention is a method that includes: tracking snapshot read requests made by a first processor core to read a plurality of cache lines; detecting a snapshot read access stream based on the tracked snapshot read requests; and issuing, based on the detected snapshot read access stream, one or more snapshot prefetch requests, including a first snapshot prefetch request to prefetch data from a first cache line that is stored in, and owned exclusively by, a first storage location outside the first processor core. The exclusive ownership of the first cache line is to remain with the first storage location after the prefetch of data from the first cache line. The method further includes storing the prefetched data in a second storage location within the first processor core. The first storage location that is outside the first processor core may be a cache of a second processor or may be the system memory that is shared by the first and second processor core. The method may further include updating an indicator of an entry in second storage location to indicate that data stored in the entry is snapshot prefetched data. Snapshot prefetched data may only be used to fill snapshot read requests issued by the first processor core. The method may further includes removing snapshot prefetched data from the second storage location when: 1) the snapshot prefetched data has been accessed by a subsequent snapshot read request; 2) the snapshot prefetched data is evicted in accordance to an eviction policy associated with the second storage location; or 3) the snapshot prefetched data has timed out. In addition, the method may include tracking the ratio between the number of snapshot prefetched data in the second storage that have been accessed by subsequent snapshot read requests and the number of snapshot prefetched data that have been evicted from the second storage location or have timed out, and responsively adjusting a rate at which the snapshot prefetch requests are issued.

Yet another example of the present invention is a system that includes a system memory, a first processor core, snapshot read tracking circuitry, and snapshot prefetch issuing circuitry. The snapshot read tracking circuitry tracks snapshot read requests made by a first processor core to read a plurality of cache lines. The snapshot read tracking circuitry may detect a snapshot read access stream based on the tracked snapshot read requests. Once a snapshot read access stream is detected, the snapshot prefetch issuing circuitry issues one or more snapshot prefetch requests based on the detected snapshot read access stream. The one or more snapshot prefetch requests includes at least a first snapshot prefetch request that is to prefetch data from a first cache line stored in, and owned exclusively by, a first storage location outside the first processor core. The prefetched data is to be stored in a second storage location within the first processor core. After the prefetch, exclusive ownership of the first cache line is to remain with the first storage location.

Each of the plurality of cache lines read by the first processor core via a snapshot read request may be associated with a respective cache coherence state. A snapshot read request is a request that, when executed, causes data stored in a target cache line to be read in a way such that after the data is read, the cache coherence state associated with the target cache line and the location in which the target cache line is stored are to remain the same. The first storage location that is outside the first processor core may be a cache of a second processor or may be the system memory that is shared by the first and second processor core. Each entry in the second storage location may include an indicator to indicate whether data stored in the entry is snapshot prefetched data. Snapshot prefetched data may only be used to fill snapshot read requests issued by the first processor core. Snapshot prefetched data may be removed from the second storage location if: 1) the snapshot prefetched data is accessed by a subsequent snapshot read request; 2) the snapshot prefetched data is evicted in accordance to an eviction policy associated with the second storage location; or 3) the snapshot prefetched data has timed out.

The system may further include a snapshot prefetch throttling circuitry to track the ratio between the number of snapshot prefetched data in the second storage that have been accessed by subsequent snapshot read requests and the number of snapshot prefetched data that have been evicted from the second storage location or have timed out. Based on this ratio, the snapshot prefetch throttling circuitry may adjust the rate at which the snapshot prefetch circuitry issues snapshot prefetch requests.

An additional example of the present invention is a computer- or machine-readable medium having code or program stored thereon which, when executed by the computer or machine, cause the computer or machine to perform a series of operations that includes: tracking snapshot read requests made by a first processor core to read a plurality of cache lines; detecting a snapshot read access stream based on the tracked snapshot read requests; and issuing, based on the detected snapshot read access stream, one or more snapshot prefetch requests, including a first snapshot prefetch request to prefetch data from a first cache line that is stored in, and owned exclusively by, a first storage location outside the first processor core. The exclusive ownership of the first cache line is to remain with the first storage location after the prefetch of data from the first cache line. The series of operations may additionally include storing the prefetched data in a second storage location within the first processor core. The first storage location that is outside the first processor core may be a cache of a second processor or may be the system memory that is shared by the first and second processor core. The series of operations may further include updating an indicator of an entry in second storage location to indicate that data stored in the entry is snapshot prefetched data. Snapshot prefetched data may only be used to fill snapshot read requests issued by the first processor core. The series of operations may further include removing snapshot prefetched data from the second storage location when: 1) the snapshot prefetched data has been accessed by a subsequent snapshot read request; 2) the snapshot prefetched data is evicted in accordance to an eviction policy associated with the second storage location; or 3) the snapshot prefetched data has timed out. In addition, the series of operations may include tracking the ratio between the number of snapshot prefetched data in the second storage that have been accessed by subsequent snapshot read requests and the number of snapshot prefetched data that have been evicted from the second storage location or have timed out, and responsively adjusting a rate at which the snapshot prefetch requests are issued.

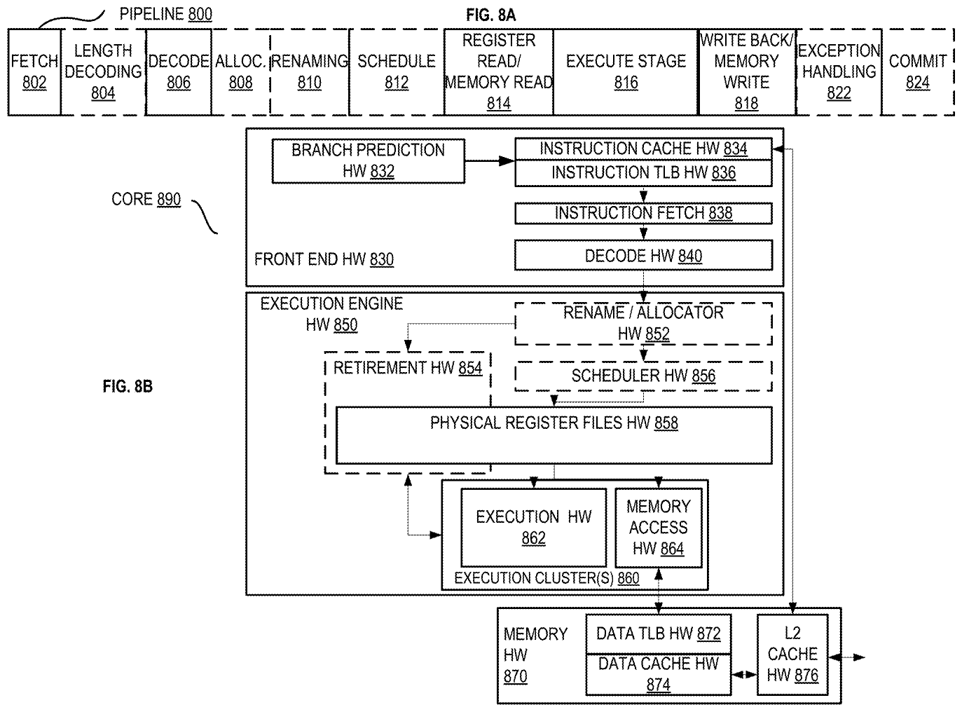

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 8B shows processor core 890 including a front end hardware 830 coupled to an execution engine hardware 850, and both are coupled to a memory hardware 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end hardware 830 includes a branch prediction hardware 832 coupled to an instruction cache hardware 834, which is coupled to an instruction translation lookaside buffer (TLB) 836, which is coupled to an instruction fetch hardware 838, which is coupled to a decode hardware 840. The decode hardware 840 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode hardware 840 or otherwise within the front end hardware 830). The decode hardware 840 is coupled to a rename/allocator hardware 852 in the execution engine hardware 850.

The execution engine hardware 850 includes the rename/allocator hardware 852 coupled to a retirement hardware 854 and a set of one or more scheduler hardware 856. The scheduler hardware 856 represents any number of different schedulers, including reservations stations, central instruction window, etc. The scheduler hardware 856 is coupled to the physical register file(s) hardware 858. Each of the physical register file(s) hardware 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 858 comprises a vector registers hardware, a write mask registers hardware, and a scalar registers hardware. This register hardware may provide architectural vector registers, vector mask registers, and general purpose registers. The physical register file(s) hardware 858 is overlapped by the retirement hardware 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 854 and the physical register file(s) hardware 858 are coupled to the execution cluster(s) 860. The execution cluster(s) 860 includes a set of one or more execution hardware 862 and a set of one or more memory access hardware 864. The execution hardware 862 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 856, physical register file(s) hardware 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 864). It should also be understood that where separate pipelines are used, one or more of these pipelines may be out-of-order issue/execution and the rest in-order.

The set of memory access hardware 864 is coupled to the memory hardware 870, which includes a data TLB hardware 872 coupled to a data cache hardware 874 coupled to a level 2 (L2) cache hardware 876. In one exemplary embodiment, the memory access hardware 864 may include a load hardware, a store address hardware, and a store data hardware, each of which is coupled to the data TLB hardware 872 in the memory hardware 870. The instruction cache hardware 834 is further coupled to a level 2 (L2) cache hardware 876 in the memory hardware 870. The L2 cache hardware 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode hardware 840 performs the decode stage 806; 3) the rename/allocator hardware 852 performs the allocation stage 808 and renaming stage 810; 4) the scheduler hardware 856 performs the schedule stage 812; 5) the physical register file(s) hardware 858 and the memory hardware 870 perform the register read/memory read stage 814; the execution cluster 860 perform the execute stage 816; 6) the memory hardware 870 and the physical register file(s) hardware 858 perform the write back/memory write stage 818; 7) various hardware may be involved in the exception handling stage 822; and 8) the retirement hardware 854 and the physical register file(s) hardware 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 834/874 and a shared L2 cache hardware 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

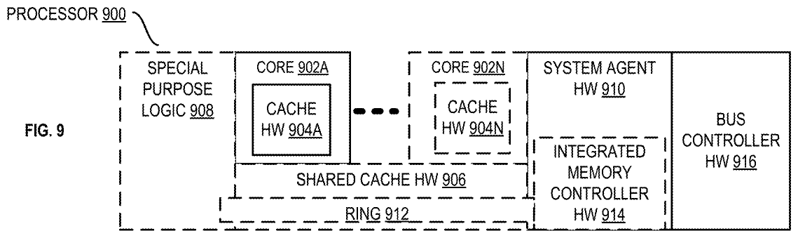

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller hardware 916, while the optional addition of the dashed lined boxes illustrates an alternative processor 900 with multiple cores 902A-N, a set of one or more integrated memory controller hardware 914 in the system agent hardware 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 906, and external memory (not shown) coupled to the set of integrated memory controller hardware 914. The set of shared cache hardware 906 may include one or more mid-level caches, such as level 2 (L2), level 3 (L3), level 4 (L4), or other levels of cache, a last level cache (LLC), and/or combinations thereof. While in one embodiment a ring based interconnect hardware 912 interconnects the integrated graphics logic 908, the set of shared cache hardware 906, and the system agent hardware 910/integrated memory controller hardware 914, alternative embodiments may use any number of well-known techniques for interconnecting such hardware. In one embodiment, coherency is maintained between one or more cache hardware 906 and cores 902-A-N.

In some embodiments, one or more of the cores 902A-N are capable of multi-threading. The system agent 910 includes those components coordinating and operating cores 902A-N. The system agent hardware 910 may include for example a power control unit (PCU) and a display hardware. The PCU may be or include logic and components needed for regulating the power state of the cores 902A-N and the integrated graphics logic 908. The display hardware is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set. In one embodiment, the cores 902A-N are heterogeneous and include both the “small” cores and “big” cores described below.

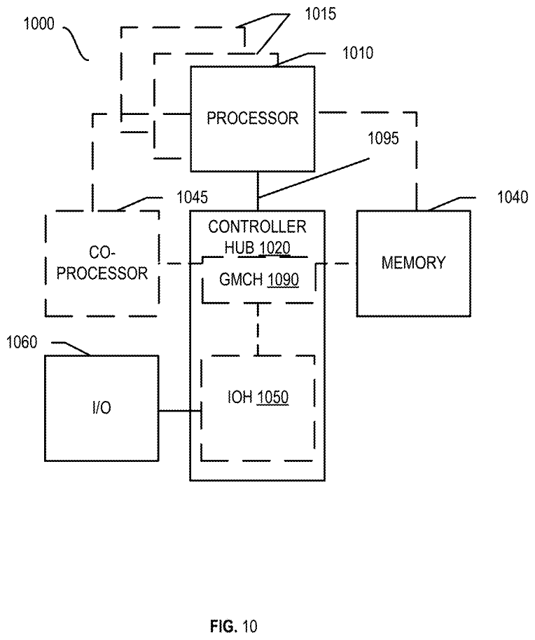

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface, or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

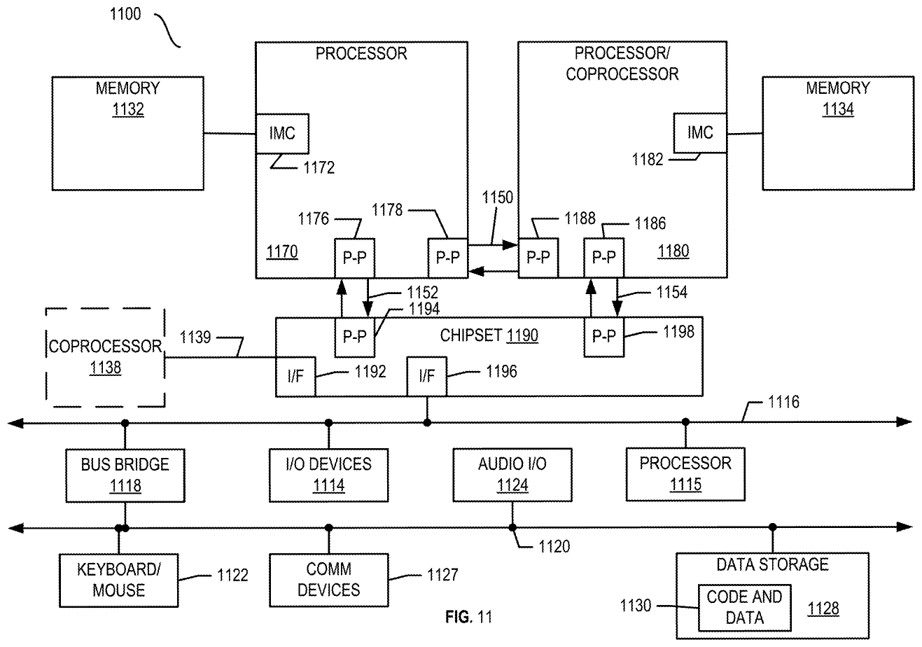

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) hardware 1172 and 1182, respectively. Processor 1170 also includes as part of its bus controller hardware point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) hardware), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage hardware 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

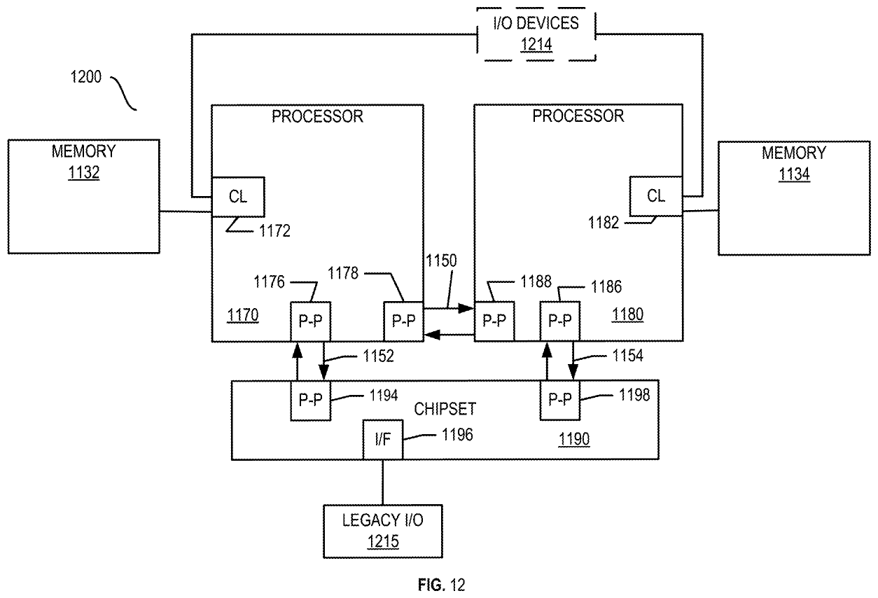

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller hardware and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

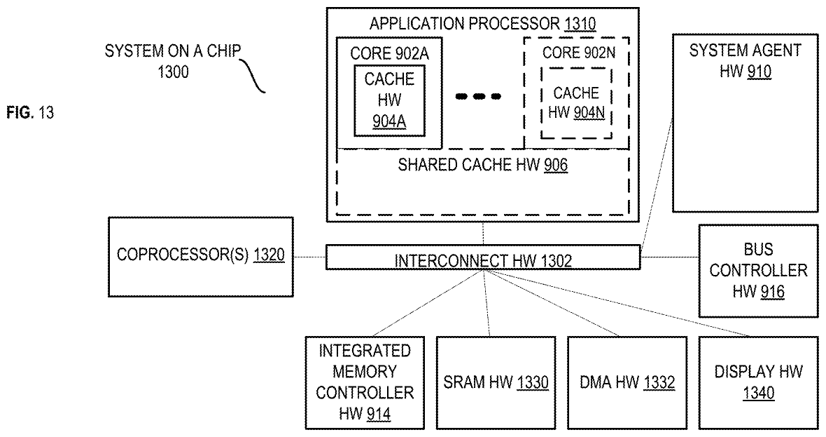

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect hardware 1302 is coupled to: an application processor 1310 which includes a set of one or more cores 902A-N and shared cache hardware 906; a system agent hardware 910; a bus controller hardware 916; an integrated memory controller hardware 914; a set or one or more coprocessors 1320 which may include integrated graphics logic, an image processor, an audio processor, and a video processor; an static random access memory (SRAM) hardware 1330; a direct memory access (DMA) hardware 1332; and a display hardware 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

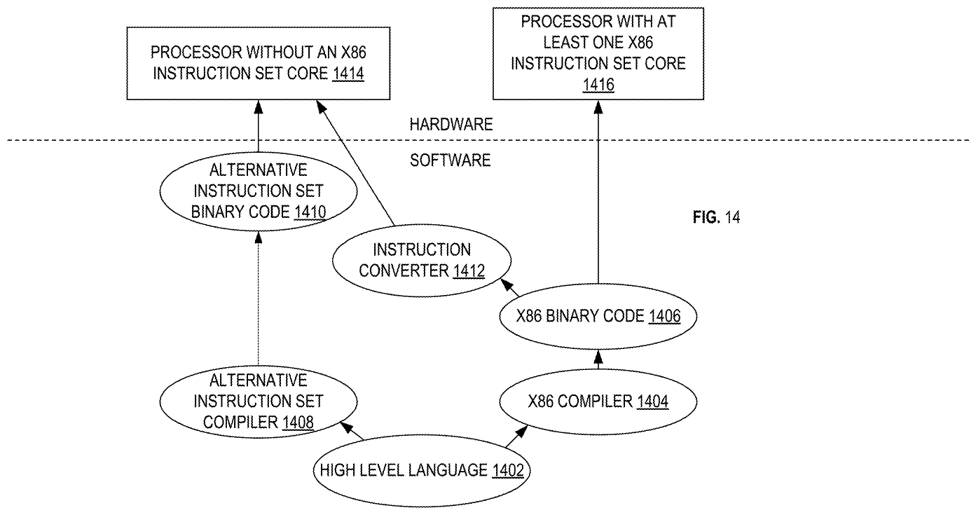

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1. An apparatus comprising:
snapshot read tracking circuitry to track snapshot read requests made by a first processor core to read a plurality of cache lines, the snapshot read tracking circuitry further to detect a snapshot read access stream based on the tracked snapshot read requests; and
snapshot prefetch issuing circuitry to issue, based on the detected snapshot read access stream, one or more snapshot prefetch requests, including a first snapshot prefetch request to prefetch data from a first cache line stored in, and owned exclusively by, a first storage location outside the first processor core, the snapshot prefetch issuing circuitry further to store the prefetched data in a second storage location within the first processor core, wherein after the prefetch, exclusive ownership of the first cache line is to remain with the first storage location.

2. The apparatus of claim 1, wherein each of the plurality of cache lines is associated with a respective cache coherence state.

3. The apparatus of claim 2, wherein each of the snapshot read requests made by the first processor core, when performed, is to cause a reading of data stored in a target cache line of the plurality of cache lines, wherein the cache coherence state associated with the target cache line and a location in which the target cache line is stored are to remain the same after the read.

4. The apparatus of claim 1, wherein the first storage location is a cache of a second processor core.

5. The apparatus of claim 1, wherein the first storage location is a system memory.

6. The apparatus of claim 1, wherein each entry in second storage location comprises an indicator to indicate whether data stored in the entry is snapshot prefetched data.

7. The apparatus of claim 6, wherein snapshot prefetched data can only be used to fill snapshot read requests issued by the first processor core.

8. The apparatus of claim 7, wherein snapshot prefetched data is removed from the second storage location when the snapshot prefetched data has been accessed by a subsequent snapshot read request, when the snapshot prefetched data is evicted in accordance to an eviction policy associated with the second storage location, or when the snapshot prefetched data has timed out.

9. The apparatus of claim 8, further comprising snapshot prefetch throttling circuitry to track a ratio between a number of snapshot prefetched data in the second storage that have been accessed by subsequent snapshot read requests and a number of snapshot prefetched data that have been evicted from the second storage location or have timed out, the snapshot prefetch throttling circuitry further to adjust a rate at which the one or more snapshot prefetch requests are issued by the snapshot prefetch circuitry based on the ratio.

10. A method comprising:
tracking snapshot read requests made by a first processor core to read a plurality of cache lines;
detecting a snapshot read access stream based on the tracked snapshot read requests;
issuing, based on the detected snapshot read access stream, one or more snapshot prefetch requests, including a first snapshot prefetch request to prefetch data from a first cache line stored in, and owned exclusively by, a first storage location outside the first processor core, wherein after the prefetch, exclusive ownership of the first cache line is to remain with the first storage location; and
storing the prefetched data in a second storage location within the first processor core.

11. The method of claim 10, further comprising associating each of the plurality of cache lines with a respective cache coherence state.

12. The method of claim 11, further comprising executing one of the snapshot read requests made by the first processor core to read data stored in a target cache line of the plurality of cache lines, the cache coherence state associated with the target cache line and a location in which the target cache line is stored remaining the same after the read.

13. The method of claim 10, wherein the first storage location is a cache of a second processor core.

14. The method of claim 10, wherein the first storage location is a system memory.

15. The method of claim 10, further comprising updating an indicator of an entry in second storage location to indicate that data stored in the entry is one of snapshot prefetched data.

16. The method of claim 15, further comprising limiting snapshot prefetched data to only be used to fill snapshot read requests issued by the first processor core.

17. The method of claim 16, further comprising:
removing snapshot prefetched data from the second storage location when: 1) the snapshot prefetched data has been accessed by a subsequent snapshot read request; 2) the snapshot prefetched data is evicted in accordance to an eviction policy associated with the second storage location; or 3) the snapshot prefetched data has timed out.

18. The method of claim 17, further comprising
tracking a ratio between a number of snapshot prefetched data in the second storage that have been accessed by subsequent snapshot read requests and a number of snapshot prefetched data that have been evicted from the second storage location or have timed out; and
responsively adjusting a rate at which the one or more snapshot prefetch requests are issued.

19. A system comprising:
a system memory;
a first processor core;
snapshot read tracking circuitry to track snapshot read requests made by the first processor core to read a plurality of cache lines, the snapshot read tracking circuitry further to detect a snapshot read access stream based on the tracked snapshot read requests; and
snapshot prefetch issuing circuitry to issue, based on the detected snapshot read access stream, one or more snapshot prefetch requests, including a first snapshot prefetch request to prefetch data from a first cache line stored in, and owned exclusively by, a first storage location outside the first processor core, the snapshot prefetch issuing circuitry further to store the prefetched data in a second storage location within the first processor core, wherein after the prefetch, exclusive ownership of the first cache line is to remain with the first storage location.

20. The system of claim 19, wherein each of the plurality of cache lines is associated with a respective cache coherence state.

21. The system of claim 20, wherein each of the snapshot read requests made by the first processor core, when performed, is to cause a reading of data stored in a target cache line of the plurality of cache lines, wherein the cache coherence state associated with the target cache line and a location in which the target cache line is stored are to remain the same after the read.

22. The system of claim 19, wherein the first storage location is a cache of a second processor core.

23. The system of claim 19, wherein the first storage location is a system memory.

24. The system of claim 19, wherein each entry in second storage location comprises an indicator to indicate whether data stored in the entry is snapshot prefetched data.

25. The system of claim 24, wherein snapshot prefetched data can only be used to fill snapshot read requests issued by the first processor core.
